(19) United States
(12) Patent Application Publication
(10) Pub. No.: US 2023/0106470 A1
(43) Pub. Date: Apr. 6, 2023

(54) METHOD FOR SYNTHESIZING NANOHYBRID FOR BONE TISSUE ENGINEERING

(71) Applicants: Shadab Bagheri khoulenjani, Tehran (IR); Hamid Mirzadeh, Tehran (IR); Nafiseh Olov, Tehran (IR); Roshanak Moradi, Tehran (IR); Saeid Amanpour, Tehran (IR)

(72) Inventors: Shadab Bagheri khoulenjani, Tehran (IR); Hamid Mirzadeh, Tehran (IR); Nafiseh Olov, Tehran (IR); Roshanak Moradi, Tehran (IR); Saeid Amanpour, Tehran (IR)

(73) Assignees: Amirkabir University of Technology, (omitted); National Institute for medical Research Development (NIMAD), Tehran (IR); Shadab Bagheri khoulenjani, Tehran (IR); Hamid Mirzadeh, Tehran (IR); Nafiseh Olov, Tehran (IR)

(21) Appl. No.: 18/073,595

(22) Filed: Dec. 2, 2022

Related U.S. Application Data
(60) Provisional application No. 63/286,051, filed on Dec. 5, 2021.

(51) Int. Cl. C08B 37/08; C08L 89/06; B82Y 30/00

(52) U.S. Cl. CPC C08B 37/003; B82Y 30/00; C08L 89/06

(57) ABSTRACT

A method for synthesizing a nanohybrid comprising forming a polymer solution by dissolving carboxymethyl chitosan and gelatin in a 2-(N-Morpholino)ethanesulfonic acid (MES) buffer, forming a first solution by adding (3-Glycidyloxypropyl)trimethoxysilane (GPTMS) to the polymer solution, forming a second solution by adding an acid-hydrolyzed tetraethyl orthosilicate (TEOS) solution to the first solution, forming a third solution by adding a calcium chloride (CaCl₂) solution to the second solution, forming a fourth solution by mixing the third solution with a solution of 1 ethyl-3-(3-dimethylaminopropyl) carbodiimide (EDC) and N-hydroxysuccinimide (NHS), forming a frozen nanohybrid, and thawing the frozen nanohybrid.

### CROSS-REFERENCE TO RELATED APPLICATION

This application claims the benefit of priority from U.S. Provisional Pat. Application Ser. No. 63/286,051, filed on Dec. 5, 2021, entitled “NOVEL INJECTABLE PREFORMED NANOHYBRID FOR BONE TISSUE REPAIR AND REGENERATION AND PREPARATION METHOD THEREOF” which is incorporated herein by reference in its entirety.

### TECHNICAL FIELD

The present disclosure is generally related to an exemplary method for synthesizing an exemplary nanohybrid for bone tissue engineering, and more particularly to an exemplary method for synthesizing an exemplary nanohybrid using an exemplary cryogelation process.

### BACKGROUND

Bone tissue engineering refers to an approach that utilizes scaffolds to seed cells and incorporate growth factors, in a bone defect site, to promote bone regeneration. The scaffolds utilized for bone tissue engineering may promote bone repair by providing an environment for cell adhesion, providing structural support, promoting cells migration, differentiation, and proliferation, and mimicking the functional activity of natural bone regeneration.

Among the different applicable biomaterials in bone tissue engineering, injectable hydrogels have been used as implantable biomaterials without the need for surgery. Hydrogels are a type of polymer scaffold, mainly composed of three-dimensional polymer chains, having superior characteristics compared to the currently-developed biomaterials, such as mimicking the natural extracellular matrix of bone tissue, providing mesh structure to control the release of nutrients, and high absorbability and integration with surrounding tissue that may avoid the complexity of surgical removal and decrease the risk of inflammatory response, infection, and potential scaring. In spite of that, injectable biomaterials may require the injection of liquid precursors including polymer solutions and crosslinking agents, capable of crosslinking polymer chains by physical and/or chemical, into an implant site. Thus, the direct injection of liquid precursors into an implant site may result in leakage of precursors to unwanted tissues and, in turn, may avoid the formation of a desired implant geometry.

Therefore, there is need for preformed hydrogel scaffolds with a defined microstructure and geometry for bone tissue engineering, which may be implanted in a defect site in a minimally invasive manner using a conventional needle.

### SUMMARY

This summary is intended to provide an overview of the subject matter of the present disclosure, and is not intended to identify essential elements or key elements of the subject matter, nor is it intended to be used to determine the scope of the claimed implementations. Its sole purpose is to present some concepts of one or more exemplary aspects in a simplified form as a prelude to the more detailed description that is presented later. The proper scope of the present disclosure may be ascertained from the claims set forth below in view of the detailed description below and the drawings.

One or more exemplary embodiments describe an exemplary method for synthesizing an exemplary nanohybrid. Exemplary method may comprise forming an exemplary polymer solution by dissolving carboxymethyl chitosan and gelatin in an exemplary 2-(N-Morpholino)ethanesulfonic acid (MES) buffer, forming an exemplary first solution by adding (3-Glycidyloxypropyl)trimethoxysilane (GPTMS) to an exemplary polymer solution, forming an exemplary second solution by adding an exemplary acid-hydrolyzed tetraethyl orthosilicate (TEOS) solution to an exemplary first solution, forming an exemplary third solution by adding an exemplary calcium chloride (CaCl2) solution to an exemplary second solution, forming an exemplary fourth solution by mixing an exemplary third solution with an exemplary solution of 1 ethyl-3-(3-dimethylaminopropyl) carbodiimide (EDC) and N-hydroxysuccinimide (NHS), forming an exemplary frozen nanohybrid by placing an exemplary fourth solution at a temperature level between about -18° C. and -22° C. for a time duration between about 12 and 48 hours, and thawing an exemplary frozen nanohybrid by placing an exemplary frozen nanohybrid at a temperature level between about 4° C. and 25° C. for a time duration between about 8 and 24 hours.

This Summary may introduce a number of concepts in a simplified format; the concepts are further disclosed within the “Detailed Description” section. This Summary is not intended to configure essential/key features of the claimed subject matter, nor is intended to limit the scope of the claimed subject matter.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which an exemplary embodiment will now be illustrated by way of example. It is expressly understood, however, that the drawings are for the purpose of illustration and description only and are not intended as a definition of the limits of the present disclosure. Exemplary embodiments will now be described by way of example in association with the accompanying drawings in which:

FIG. 1 illustrates an exemplary flowchart of exemplary method for synthesizing an exemplary nanohybrid, consistent with one or more exemplary embodiments of the present disclosure;

FIG. 2 shows Fourier-transform infrared (FT-IR) spectra of an exemplary nanohybrid containing exemplary bioglass nanoparticles and an exemplary nanohybrid lacking exemplary bioglass nanoparticles, consistent with one or more exemplary embodiments of the present disclosure;

FIG. 3 illustrates elemental mapping of Silicon, Calcium, and Chlorine in an exemplary nanohybrid containing exemplary bioglass nanoparticles analyzed by scanning electron microscopy (SEM) with energy dispersive X-Ray (EDX) analysis, consistent with one or more exemplary embodiments of the present disclosure;

FIG. 4 illustrates elemental analysis spectra of an exemplary nanohybrid containing exemplary bioglass nanoparticles, consistent with one or more exemplary embodiment of the present disclosure;

FIG. 5 illustrates SEM images of an exemplary nanohybrid containing exemplary bioglass nanoparticles at 500 µm and 3 µm, consistent with one or more exemplary embodiments of the present disclosure;

FIG. 6 illustrates transmission electron microscopy (TEM) images of an exemplary nanohybrid containing exemplary bioglass nanoparticles at 900 nm and 150 nm, consistent with one or more exemplary embodiments of the present disclosure;

FIG. 7 illustrates plots of X-ray diffraction (XRD) pattern analysis of an exemplary nanohybrid lacking exemplary bioglass nanoparticles and an exemplary nanohybrid containing exemplary bioglass nanoparticles, consistent with one or more exemplary embodiments of the present disclosure;

FIG. 8 illustrates a graph of swelling behavior of an exemplary nanohybrid containing exemplary bioglass nanoparticles within 8 hours at 7 time points in phosphate-buffered saline (PBS), consistent with one or more exemplary embodiments of the present disclosure;

FIG. 9 illustrates a graph of compressive stress-strain analysis of an exemplary nanohybrid containing exemplary bioglass nanoparticles during two reversible cycles of stress, up to a maximum strain 80%, consistent with one or more exemplary embodiments;

FIG. 10 illustrates a graph of thermal gravimetric analysis of three exemplary samples including exemplary nanohybrids containing different ratios of exemplary bioglass nanoparticles to polymer (0%, 0.38%, and 0.5%) in a temperature range between 0° C. and 800° C., consistent with one or more exemplary embodiments of the present disclosure; and

FIG. 11 shows chart of cell viability analysis of L929 mouse fibroblast cells after 48 hours of incubating the L929 mouse fibroblast cells with different exemplary nanohybrids, consistent with one or more exemplary embodiments of the present disclosure.

### DETAILED DESCRIPTION

In the following detailed description, numerous specific details are set forth by way of examples to provide a thorough understanding of the relevant teachings related to the exemplary embodiments. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in one or more exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be plain to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Disclosed herein is an exemplary method for synthesizing an exemplary nanohybrid for bone tissue engineering. In one or more exemplary embodiments, an exemplary nanohybrid may comprise an exemplary organic phase and an exemplary mineral phase. An exemplary organic phase may include an exemplary polymeric phase and an exemplary mineral phase may include exemplary bioglass nanoparticles. In an exemplary embodiment, both of an exemplary organic phase and an exemplary mineral phase of an exemplary nanohybrid may be synthesized through an exemplary cryogelation process. “Cryogelation” may refer to a process in which gelation may occur under freezing conditions, leading to the formation of a polymer network cross-linked around ice crystals. Following thawing of ice crystals, a polymeric material with an interconnected, macroporous network may be left which may be surrounded by a highly dense polymer wall.

In one or more exemplary embodiments, an exemplary nanohybrid may comprise exemplary bioglass nanoparticles. “Bioglass” may refer to a family of bioactive glasses composed of sodium oxide, silicon dioxide, phosphorous pentoxide, and calcium oxide. Bioglasses may have a surface pore structure, with a significant pore volume, surface area, ability to induce apatite formation, and cytocompatibility. In an exemplary embodiment, exemplary bioglass nanoparticles composing an exemplary nanohybrid may comprise a plurality of Si—O—Si linkages. Exemplary plurality of Si—O—Si linkages may couple an exemplary chain of carboxymethyl chitosan to an exemplary chain of gelatin.

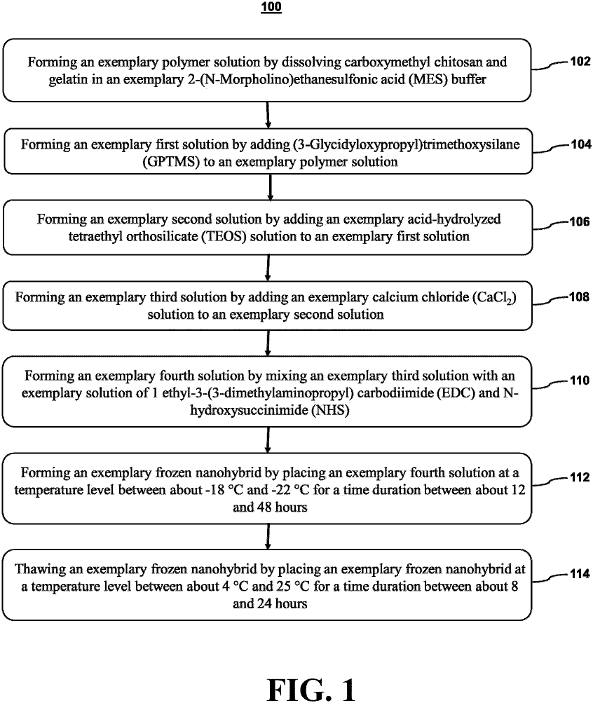

FIG. 1 illustrates an exemplary flowchart of exemplary method 100 for synthesizing an exemplary nanohybrid, consistent with one or more exemplary embodiments of the present disclosure. In one or more exemplary embodiments, exemplary method 100 may include forming an exemplary polymer solution by dissolving carboxymethyl chitosan and gelatin in an exemplary 2-(N-Morpholino)ethanesulfonic acid (MES) buffer (step 102); forming an exemplary first solution by adding (3-Glycidyloxypropyl)trimethoxysilane (GPTMS) to an exemplary polymer solution (step 104); forming an exemplary second solution by adding an exemplary acid-hydrolyzed tetraethyl orthosilicate (TEOS) solution to an exemplary first solution (step 106); forming an exemplary third solution by adding an exemplary calcium chloride (CaCl2) solution to an exemplary second solution (step 108); forming an exemplary fourth solution by mixing an exemplary third solution with an exemplary solution of 1 ethyl-3-(3-dimethylaminopropyl) carbodiimide (EDC) and N-hydroxysuccinimide (NHS) (step 110); forming an exemplary frozen nanohybrid by placing an exemplary fourth solution at a temperature level between about -18° C. and -22° C. for a time duration between about 12 and 48 hours (step 112); and thawing an exemplary frozen nanohybrid by placing an exemplary frozen nanohybrid at a temperature level between about 4° C. and 25° C. for a time duration between about 8 and 24 hours (step 114).

In further detail with respect to step 102, step 102 may include forming an exemplary polymer solution by dissolving carboxymethyl chitosan and gelatin in an exemplary MES buffer. In one or more exemplary embodiments, forming an exemplary polymer solution by dissolving carboxymethyl chitosan and gelatin in a MES buffer may comprise mixing carboxymethyl chitosan, with a degree of substitution (DS) between 0.5 and 1.5, and gelatin with an exemplary MES buffer with a pH level between 3.4 and 4.5, using a mixer, such as a magnetic stirrer. In an exemplary embodiment, an exemplary polymer solution may comprise carboxymethyl chitosan (with the DS between 0.5 and 1.5) and gelatin with a weight ratio (carboxymethyl chitosan:gelatin) between about 0.25:0.75 and 0.75:0.25. In an exemplary embodiment, an exemplary polymer solution may comprise carboxymethyl chitosan (with the DS between 0.5 and 1.5) and gelatin with a weight ratio (carboxymethyl chitosan:gelatin) of about 0.50:0.50. In an exemplary embodiment, forming an exemplary polymer solution by dissolving carboxymethyl chitosan and gelatin in an exemplary MES buffer may comprise adding carboxymethyl chitosan (with a DS value of about 1.2) and gelatin with a weight ratio (carboxymethyl chitosan:gelatin) of about 0.50:0.50 to an exemplary MES buffer (with a pH level between 3.4 and 4.5) and stirring the formed mixture for a predetermined duration of time, e.g., between about 10 and 35 hours. In one or more exemplary embodiments, an exemplary polymer solution may further include at least one of alginate, collagen, dextran, keratin, cellulose, hyaluronic acid, silk fibroin, extracted ECM, and a combination thereof.

In further detail with respect to step 104, step 104 may include forming an exemplary first solution by adding GPTMS to an exemplary polymer solution. In one or more exemplary embodiments, forming an exemplary first solution by adding GPTMS to an exemplary polymer solution may include adding drop wisely GPTMS into an exemplary polymer solution so that an exemplary final concentration of GPTMS in the first solution may become between about 0.01 M and 0.05 M. In an exemplary embodiment, forming an exemplary first solution by adding GPTMS to an exemplary polymer solution may include adding drop wisely about 0.01-0.05 g of GPTMS into about 1-6 mL of an exemplary polymer solution, while mixing using a stirrer.

In further detail with respect to step 106, step 106 may include forming an exemplary second solution by adding an exemplary acid-hydrolyzed TEOS solution to an exemplary first solution. In an exemplary embodiment, adding an exemplary acid-hydrolyzed TEOS solution to an exemplary first solution may include adding an exemplary acid-hydrolyzed TEOS solution with a TEOS concentration between about 10 M and 20 M to an exemplary first solution. In an exemplary embodiment, an exemplary acid-hydrolyzed TEOS solution may comprise hydrogen chloride (HCl) with a concentration between about 0.4 M and 0.6 M. In one or more exemplary embodiments, an exemplary acid-hydrolyzed TEOS solution may be prepared by adding about 0.03-0.1 g of TEOS to an exemplary HCl solution—while being stirred for about 5-30 min—such that the formed exemplary acid-hydrolyzed TEOS solution may have a TEOS concentration of about 10-20 M and a HCl concentration of about 0.4-0.6 M. In an exemplary embodiment, the formed exemplary acid-hydrolyzed TEOS solution may have a TEOS concentration of about 15 M and a HCl concentration of about 0.5 M.

In further detail with respect to step 108, step 108 may include forming an exemplary third solution by adding an exemplary CaCl₂ solution to an exemplary second solution. In an exemplary embodiment, forming an exemplary third solution by adding an exemplary CaCl₂ solution to an exemplary second solution may include adding an exemplary CaCl₂ solution with a CaCl₂ concentration of about 2%-10% w/v to an exemplary second solution, while mixing using a stirrer, such as a magnetic stirrer.

In further detail with respect to step 110, step 110 forming an exemplary fourth solution by mixing an exemplary third solution with an exemplary solution of EDC and NHS (EDC/NHS solution). In an exemplary embodiment, mixing an exemplary third solution with an exemplary EDC/NHS solution may include mixing an exemplary third solution with an exemplary EDC/NHS solution comprising EDC and NHS with a molar ratio (EDC:NHS) between about 0.8:1.2 and 1.2:0.8, while mixing using a stirrer, such as a magnetic stirrer. In an exemplary embodiment, mixing an exemplary third solution with an exemplary EDC/NHS solution may include mixing an exemplary third solution with an exemplary EDC/NHS solution comprising EDC and NHS with a molar ratio (EDC:NHS) of about 1:1.

In an exemplary embodiment, with further reference to step 110, an exemplary fourth solution may comprise CaCl₂ with a concentration between about 0.01 M and 0.06 M. In one or more exemplary embodiments, an exemplary fourth solution may comprise EDC with a concentration between about 0.05 M and 0.15 M. In one or more exemplary embodiments, an exemplary forth solution may comprise NHS with a concentration between about 0.05 M and 0.15 M. In one or more exemplary embodiments, an exemplary fourth solution may comprise TEOS with a concentration between about 0.05 M and 0.10 M. In an exemplary embodiment, an exemplary fourth solution may comprise CaCl₂ with a concentration between about 0.03 M and 0.04 M, EDC with a concentration between about 0.08 M and 0.1 M, NHS with a concentration between about 0.08 M and 0.1 M, and TEOS with a concentration between about 0.06 M and 0.09 M.

In further detail with respect to step 112, step 112 may include forming an exemplary frozen nanohybrid by placing an exemplary fourth solution at a temperature level between about -18° C. and -22° C. for a time duration between about 12 and 48 hours. In an exemplary embodiment, placing an exemplary fourth solution at a temperature level between -about 18° C. and -22° C. for a time duration between about 12 and 48 hours may include placing an exemplary fourth solution at about -20° C. for a time duration of about 24 hours. In one or more exemplary embodiments, an exemplary frozen nanohybrid may be formed by pipetting an exemplary fourth solution into an exemplary cylindrical polystyrene mold and placing an exemplary cylindrical polystyrene mold in a freezer set to a temperature level between -18° C. and -22° C. for a time duration between about 12 and 48 hours. In one or more exemplary embodiments, an exemplary cylindrical polystyrene mold may have an exemplary diameter between about 5 mm and 10 mm, and an exemplary thickness between about 1 mm and 5 mm. In an exemplary embodiment, an exemplary frozen nanohybrid may be formed by pipetting an exemplary fourth solution into an exemplary cylindrical polystyrene mold (5 mm diameter, 2 mm thickness) and placing an exemplary cylindrical polystyrene mold in a freezer set to a temperature level between about -18° C. and -22° C. for a time duration between about 12 and 48 hours.

In further detail with respect to step 114, step 114 may include thawing an exemplary frozen nanohybrid by placing an exemplary frozen nanohybrid at a temperature level between about 4° C. and 25° C. for a time duration between about 8 and 24 hours. In an exemplary embodiment, thawing an exemplary frozen nanohybrid by placing an exemplary frozen nanohybrid at a temperature level between about 4° C. and 25° C. for a time duration between about 8 and 24 hours may include thawing an exemplary frozen nanohybrid by placing an exemplary frozen nanohybrid at a temperature level of about 4° C. for a time duration of about 24 hours. Exemplary method 100 may allow in-situ synthesis of exemplary bioglass nanoparticles during an exemplary cryopolymerization/cryogelation process at minus temperature levels, e.g., between about -18° C. and -22° C. “In-situ synthesis” may refer to formation of exemplary bioglass nanoparticle during an exemplary process of synthesizing an exemplary nanohybrid. In conventional methods, formation of bioglass nanoparticles may be accomplished at high temperatures (at least 40-60° C.) because functional groups of bioglass precursors (i.e., TEOS and GPTMS) may be activated after exposing bioglass precursors to high temperature levels. Nevertheless, applying high temperature levels for synthesizing bioglass nanoparticles may result in fabrication of nanohybrids with small pores, low porosity, and low mechanical strength. Meanwhile, due to the formation of bioglass nanoparticles at high temperature levels in conventional methods, using cryogelation process for synthesizing nanohybrids that contain bioglass nanoparticles has not been possible (cryogelation occurs at minus temperature levels). Exemplary method 100 may comprise a cryogelation process in which functional groups of exemplary bioglass precursors (i.e., TEOS and GPTMS) may be activated at temperature levels between about -18° C. and -22° C.

### EXAMPLES

Hereinafter, one or more exemplary embodiments will be described in further detail with reference to examples. It will be obvious to a person having ordinary skill in the art that these examples may be for illustrative purposes only and are not to be interpreted to limit the scope of the present disclosure.

### Example 1: Fabrication of the Nanohybrid

In this example, an exemplary nanohybrid comprising an exemplary carboxymethyl chitosan, an exemplary gelatin, and exemplary bioglass nanoparticles was synthesized based a method similar to exemplary method 100. In an exemplary implementation, an exemplary polymer solution was formed by dissolving gelatin and carboxymethyl chitosan (with a degree of substitution (DS) value of about 1.2) with a weight ratio (gelatin:carboxymethyl chitosan) of about 0.50:0.50 in a 2-(N-Morpholino)ethanesulfonic acid (MES) buffer (pH=4). In an exemplary implementation, to prepare an exemplary polymer solution, first, about 0.1 g carboxymethyl chitosan (with a DS value of 1.2) was dissolved in about 3 mL of an exemplary MES buffer by continuous stirring for about 24 hours. Then, about 0.1 g of gelatin was added to the formed carboxymethyl chitosan solution and stirred for another 4 hours until a clear liquid was formed. Subsequently, an exemplary first solution was prepared by adding about 0.0375 g of (3-Glycidyloxypropyl)trimethoxysilane (GPTMS) to the formed polymer solution.

An exemplary acid-hydrolyzed tetraethyl orthosilicate (TEOS) solution was prepared by adding about 0.057 g of TEOS to a hydrogen chloride (HCl) solution—while being stirred for about 10 min—such that the formed acid-hydrolyzed TEOS solution may have a TEOS concentration of about 15 M and a HCl concentration of about 0.5 M. The formed acid-hydrolyzed TEOS solution was then mixed with an exemplary first solution with a volume ratio (acid-hydrolyzed TEOS solution:first solution) of about 1:100 to form an exemplary second solution.

An exemplary third solution was formed by adding an exemplary 5% w/v calcium chloride (CaCl2) solution to an exemplary second solution. Instantly, following addition of an exemplary 5% w/v CaCl₂ solution to an exemplary second solution, an exemplary fourth solution was prepared by adding 2 mL of a solution of 1 ethyl-3-(3-dimethylaminopropyl) carbodiimide (EDC) and N-hydroxysuccinimide (NHS)—i.e., an exemplary EDC/NHS solution—with a molar ratio (EDC:NHS) of about 1:1 to an exemplary third solution. In an exemplary embodiment, an exemplary fourth solution may comprise CaCl₂ with a concentration of about 0.034 M, EDC with a concentration of about 0.1 M, NHS with a concentration of about 0.1 M, and TEOS with a concentration of about 0.075 M.

In one or more exemplary embodiments, an exemplary fourth solution may be pipetted into exemplary cylindrical polystyrene molds (5 mm diameter, 2 mm thickness) and placed in a freezer set to a temperature level between -18° C. and -22° C. for a time duration between 12 and 48 hours (cryopolymerization/cryogelation process). In an exemplary embodiment, an exemplary fourth solution may be pipetted into exemplary cylindrical polystyrene molds (5 mm diameter, 2 mm thickness) and placed in a freezer set to about -20° C. for a time duration of about 24 hours. An exemplary frozen nanohybrid may be formed after an exemplary cryopolymerization process (-20° C., 24 hours). An exemplary frozen nanohybrid may be thawed by placing an exemplary nanohybrid in a fridge set to about 4° C. for a time duration of about 24 hours.

### Example 2: Fourier Transform Infrared Spectroscopy of the Nanohybrid

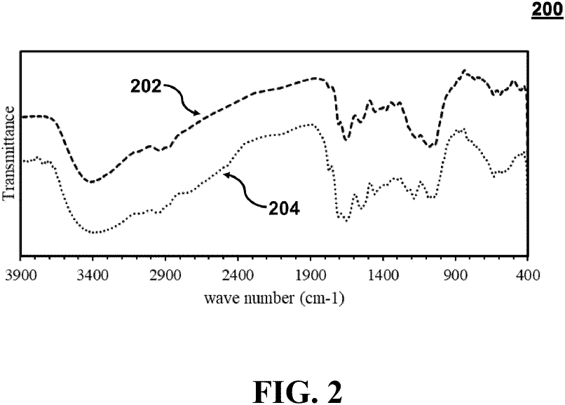

In this example, the chemical structure of an exemplary nanohybrid that was synthesized as described in one or more exemplary embodiments was evaluated by Fourier-transform infrared (FT-IR) spectroscopy. FIG. 2 shows FT-IR spectra 200 of an exemplary nanohybrid containing exemplary bioglass nanoparticles (FT-IR spectrum 202) and an exemplary nanohybrid lacking exemplary bioglass nanoparticles (FT-IR spectrum 204), consistent with one or more exemplary embodiments of the present disclosure. Referring to FIG. 2, the appeared peaks at 1653 cm⁻¹ and 1552 cm⁻¹ wavelengths of FT-IR spectrum 202 and FT-IR spectrum 204, respectively, may correspond to a primary amid and a secondary amid of gelatin. Absorption of the primary amid may be due to the vibration of a C═O group, and absorption of the secondary amid may be due to the coupling of N—H bending with the stretch of C—H bond. The overlap of N—H groups in gelatin and carboxymethyl chitosan formed a double-peak in the region of 1653-1703 cm⁻¹, in FT-IR spectrum 202 and FT-IR spectrum 204, which may confirm the formation of an exemplary scaffold of gelatin and carboxymethyl chitosan. Moreover, an exemplary characteristic peak of Si—O—Si was appeared at 1075 cm⁻¹ wavelength. However, the characteristic peak of Si—O—Si was covered by an exemplary symmetric tension of C—O—C bond in carboxymethyl chitosan. Thus, the formation of Si—O—Si, as a characteristic of bioglass formation in an exemplary nanohybrid, may not be confirmed using only FT-IR spectroscopy.

### Example 3: Evaluation of the Distribution of the Bioglass Nanoparticles in the Nanohybrid

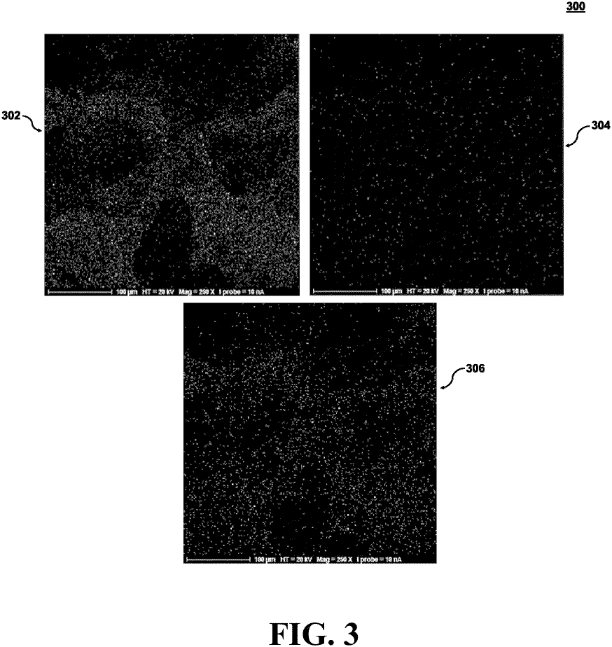

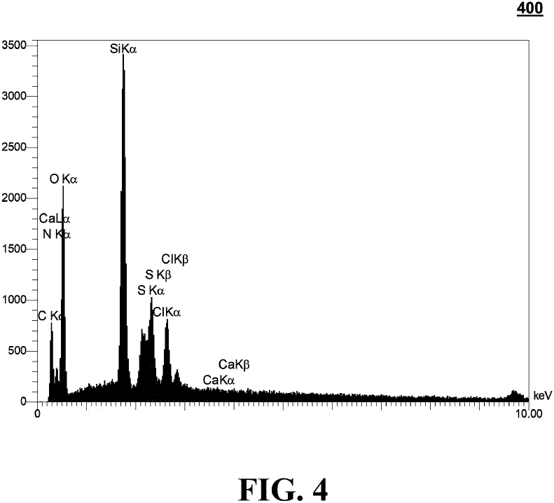

In this example, distribution of exemplary bioglass nanoparticles in an exemplary nanohybrid was evaluated by scanning electron microscope (SEM) and elemental analysis. FIG. 3 illustrates elemental mapping 300 of Silicon 302, Calcium 304, and Chlorine 306 in an exemplary nanohybrid containing exemplary bioglass nanoparticles analyzed by SEM with energy dispersive X-Ray (EDX) analysis, consistent with one or more exemplary embodiments of the present disclosure. FIG. 4 illustrates elemental analysis spectra 400 of an exemplary nanohybrid containing exemplary bioglass nanoparticles, consistent with one or more exemplary embodiment of the present disclosure. Referring to FIG. 3 and FIG. 4, elemental mapping 300 and elemental analysis spectra 400 may show that Silicon (Si) element, as a characteristic element of exemplary bioglass nanoparticles, Calcium (Ca) element, and Chlorine (Cl) element may be homogenously dispersed in the structure of an exemplary nanohybrid. Table 1 bellow shows the percentage of exemplary chemical elements present in the structure of an exemplary nanohybrid containing exemplary bioglass nanoparticles, consistent with one or more exemplary embodiments.

The amount of exemplary chemical elements present in the structure of an exemplary nanohybrid containing exemplary bioglass nanoparticles, consistent with one or more exemplary embodiments of the present disclosure.

TABLE 1

| hemical Element | Percentage |
|---|---|
| Carbon | 24.31 |
| Nitrogen | 9.22 |
| Oxygen | 43.95 |
| Silicon | 13.71 |
| Sulfur | 4.90 |
| Chlorine | 3.48 |
| Calcium | 0.43 |

In an exemplary embodiment, as illustrated in elemental analysis spectra 400, Silicon (Si) has the highest peak intensity—after the peaks of Carbon, Nitrogen, and Oxygen— in the structure of an exemplary nanohybrid containing exemplary bioglass nanoparticles.

### Example 4: Morphological Characteristics of the Nanohybrid

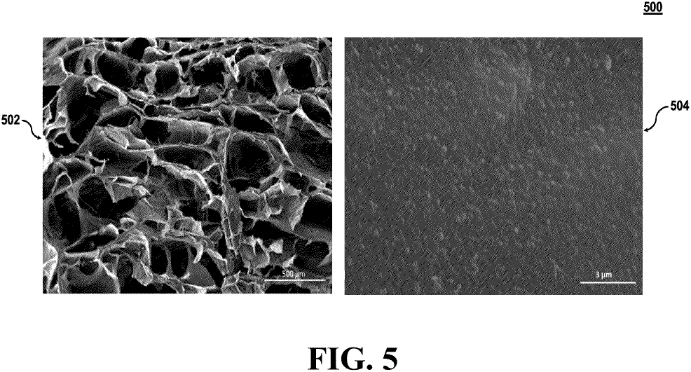

In this example, the microstructure of an exemplary nanohybrid containing exemplary bioglass nanoparticles, which was fabricated as described in one or more exemplary embodiments, was studied using SEM and transmission electron microscopy (TEM). FIG. 5 illustrates SEM images 500 of an exemplary nanohybrid containing exemplary bioglass nanoparticles at 500 µm (502) and 3 µm (504), consistent with one or more exemplary embodiments of the present disclosure. SEM images 500 of an exemplary nanohybrid containing exemplary bioglass nanoparticles at 500 µm (502) may show the porosity, pore size, pore size distribution, and pore morphology of an exemplary nanohybrid containing exemplary bioglass nanoparticles. On the other hand, SEM images 500 of an exemplary nanohybrid containing exemplary bioglass nanoparticles at 3 µm (504) may show the surface area of exemplary pores and the presence of exemplary bioglass nanoparticles. SEM images 500 confirm the formation of exemplary bioglass nanoparticles and homogenous pores with an average size of about 326.5 µm. Meanwhile, the porosity of an exemplary nanohybrid containing exemplary bioglass nanoparticles was measured to be about 89%. A highly porous nanohybrid with a proper pore size may increase the cellular infiltration and proliferation of osteoblasts.

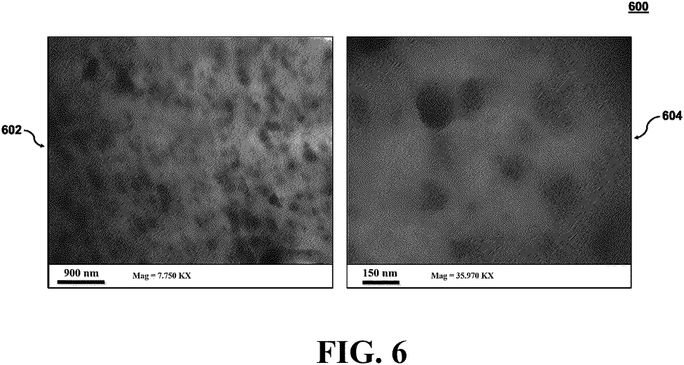

FIG. 6 illustrates TEM images 600 of an exemplary nanohybrid containing exemplary bioglass nanoparticles at 900 nm (602) and 150 nm (604), consistent with one or more exemplary embodiments of the present disclosure. TEM images 600 may show that exemplary bioglass nanoparticles were properly distributed on the surface of the pores’ walls. TEM images 600 may also show that the organic phase of an exemplary nanohybrid (i.e., gelatin and carboxymethyl chitosan polymers) and the inorganic phase of an exemplary nanohybrid (i.e., exemplary bioglass nanoparticles) are properly integrated with one another.

### Example 5: Evaluation of the Degree of Crystallinity

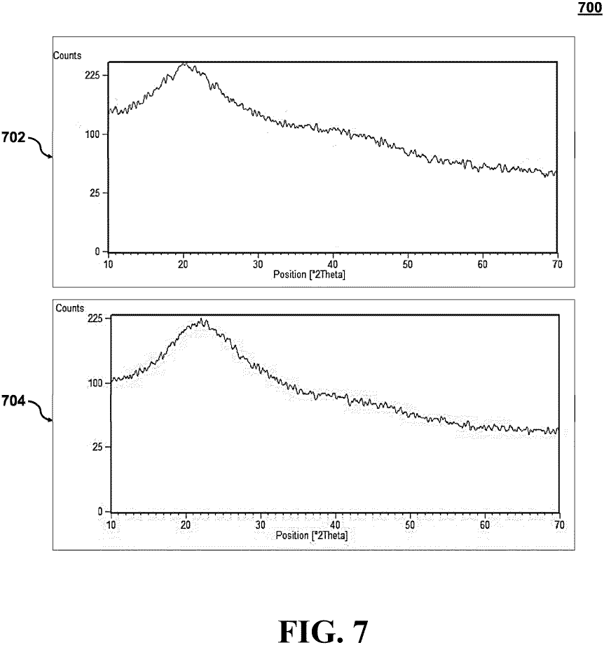

In this example, the degree of crystallinity of an exemplary nanohybrid containing exemplary bioglass nanoparticles was measure by X-ray diffraction (XRD) analysis. FIG. 7 illustrates plots 700 of XRD pattern analysis of an exemplary nanohybrid lacking exemplary bioglass nanoparticles and an exemplary nanohybrid containing exemplary bioglass nanoparticles, consistent with one or more exemplary embodiments of the present disclosure. Referring to plots 700, plot 702 illustrates XRD pattern of an exemplary nanohybrid lacking exemplary bioglass nanoparticles and plot 704 illustrates XRD pattern of an exemplary nanohybrid containing exemplary bioglass nanoparticles. Both of plot 702 and plot 704 showed a broad peak at 20° (2Theta) that may correspond to a low crystallinity of carboxymethyl chitosan gelatin. It may be appreciated that a highly crystalline structure may decrease the free movement of polymer chains, such as gelatin and carboxymethyl chitosan chains, leading to a poor shape memorizing of an exemplary nanohybrid. FIG. 7 shows that an exemplary nanohybrid, synthesized based on one or more exemplary embodiments, had a strong shape memory property.

### Example 6: Evaluation of Swelling and Water Uptake of the Nanohybrid

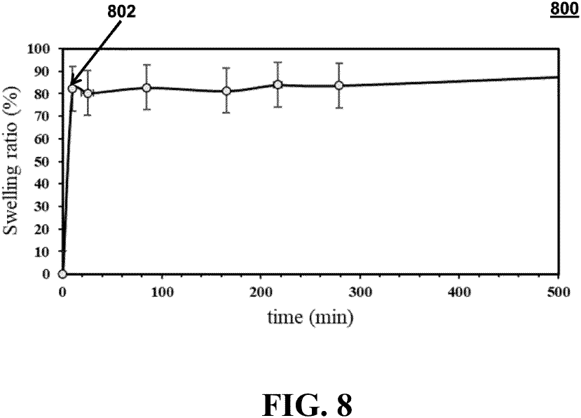

The swelling behavior of an exemplary nanohybrid may affect the biological performance and mechanical properties of an exemplary nanohybrid, as well as the diffusion rate of fluids in an exemplary nanohybrid. FIG. 8 illustrates graph 800 of swelling behavior of an exemplary nanohybrid containing exemplary bioglass nanoparticles within 8 hours at 7 time points in phosphate-buffered saline (PBS), consistent with one or more exemplary embodiments of the present disclosure. Referring to graph 800, the swelling ratio of an exemplary nanohybrid containing exemplary bioglass nanoparticles may reach a maximum after 5-10 min. After 5-10 min, no significant change was observed in the swelling ratio of an exemplary nanohybrid containing exemplary bioglass nanoparticles. Thus, graph 800 may reveal that an exemplary nanohybrid containing exemplary bioglass nanoparticles may be able to uptake water in a short duration of time, e.g., 5-10 min. Referring to FIG. 8, maximum peak 802—appeared in graph 800 before reaching a constant ratio—may indicate the release of non-reacting material from an exemplary nanohybrid containing exemplary bioglass nanoparticles. After reaching maximum peak 802, an exemplary nanohybrid may maintain a constant weight in the presence of water. Meanwhile, graph 800 may show that an exemplary nanohybrid may be capable of absorbing up to 10-fold water of its initial weight. Graph 800 showed that the amount of sol in an exemplary nanohybrid containing exemplary bioglass nanoparticles was significantly low (about 10% of the weight of an exemplary nanohybrid), indicating that about 90% of exemplary polymers in an exemplary nanohybrid were cross-linked by exemplary cross-linkers set forth in one or more exemplary embodiments, i.e., GPTMS, TEOS, and Ca²⁺.

### Example 7: Evaluation of the Compressive Mechanical Properties of the Nanohybrid

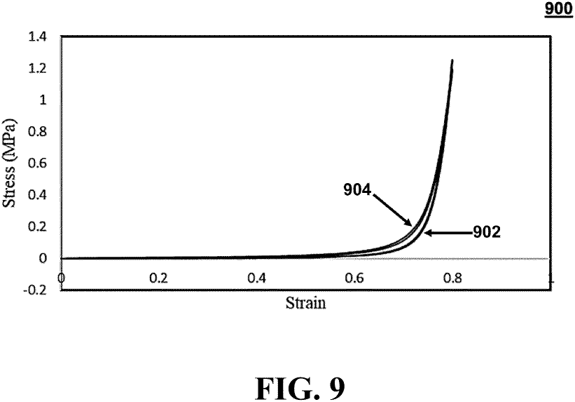

In this example the compressive mechanical properties (i.e., elastic module, maximum stress, and maximum strain) of exemplary cylindrical samples of an exemplary nanohybrid, synthesized based on one or more exemplary embodiments, was measured under 60 N load at a crosshead speed of 1.2 mm/min. FIG. 9 illustrates graph 900 of compressive stress-strain analysis of an exemplary nanohybrid containing exemplary bioglass nanoparticles during two reversible cycles of stress, up to a maximum strain 80% (curve 902 and curve 904), consistent with one or more exemplary embodiments. Referring to FIG. 9, graph 900 shows that the area under curve 902 and curve 904 is significantly low, indicating the elastic and reversible behavior of exemplary cylindrical samples of an exemplary nanohybrid. The area under curve 904 was non-significantly more than curve 902, showing that the strength of exemplary cylindrical samples was non-significantly decreased after being subjected to a stress cycle. The elastic module of exemplary cylindrical samples of the nanohybrid was measured to be about 158 kPa.

### Example 8: Thermal Behavior of the Nanohybrid

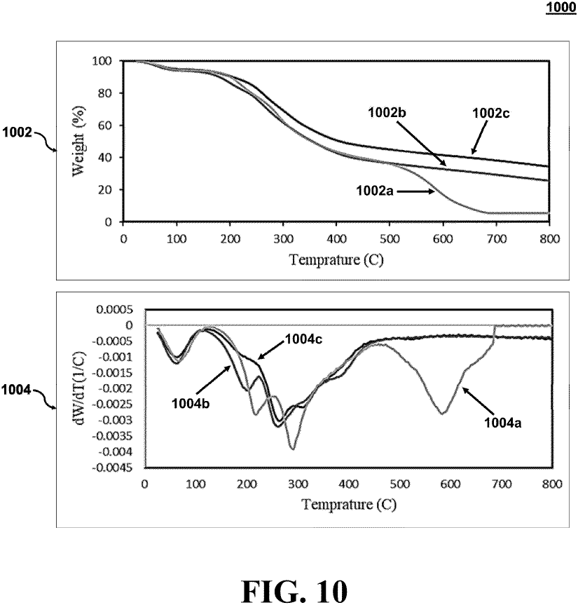

In this example, the thermal stability of exemplary nanohybrids, containing different ratios of exemplary bioglass nanoparticles to polymer (0%, 0.38%, and 0.5%), by thermal gravimetric analysis. FIG. 10 illustrates graphs 1000 of thermal gravimetric analysis of three exemplary samples including exemplary nanohybrids containing different ratios of exemplary bioglass nanoparticles to polymer (0%, 0.38%, and 0.5%) in a temperature range between 0° C. and 800° C., consistent with one or more exemplary embodiments of the present disclosure. Referring to graphs 1000, graph 1002 represents weight loss behavior of exemplary samples of an exemplary nanohybrid containing different ratios of exemplary bioglass nanoparticles to polymer (0% (1002a), 0.38% (1002b), and 0.5% (1002c)). Graph 1004 represents the derivative of weight loss as a function of the temperature of exemplary samples of an exemplary nanohybrid containing different ratios of exemplary bioglass nanoparticles to polymer (0% (1004a), 0.38% (1004b), and 0.5% (1004c)).

Graph 1004 shows at least three weight loss; a first weight loss was observed at 90° C. which may correspond to the evaporation of the absorbed water in exemplary samples of an exemplary nanohybrid. Referring again to graph 1004, a second and a third weight loss were observed in the range of 200-300° C. which may correspond to the degradation of gelatin and carboxymethyl chitosan. The remaining ash of exemplary samples containing different ratios of exemplary bioglass nanoparticles to polymer (0%, 0.38%, and 0.5%), after heat absorbance up to 800° C., comprise 34%, 25%, and 5% inorganic phase, respectively. Graphs 1000 show that the real amount of exemplary bioglass nanoparticles was less than the nominal amount of exemplary bioglass nanoparticles in exemplary samples with 0%, 0.38%, and 0.5% (mineral phase:polymer) ratio. Graphs 1000 show that unreacted reagent for synthesizing exemplary bioglass nanoparticles may be extracted through an exemplary thawing step, as explained in “Example 1”.

### Example 9: Injectability Property of the Nanohybrid

In this example, the injectability property of an exemplary nanohybrid containing exemplary bioglass nanoparticles was measured by placing an exemplary sample of the nanohybrid, with 5 mm diameter and 2 mm height, into a 5 mL syringe and continuously ejecting through a 16-gauge needle. Due to shear stress during injection, an exemplary nanohybrid was successfully passed through a 16-gauge needle without clogging and structural disruption, proving its thixotropic nature.

### Example 10: Cytotoxicity Analysis of the Nanohybrid

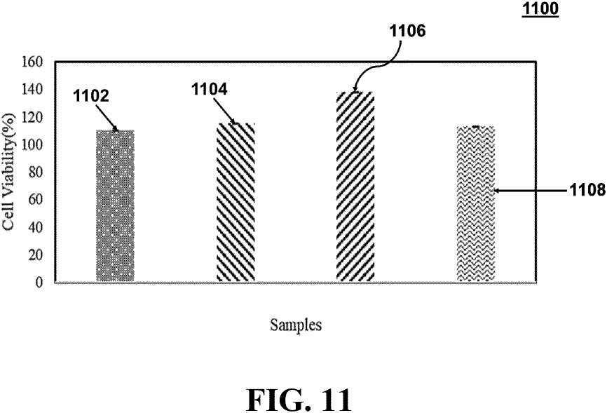

In this example, cytotoxicity of different exemplary nanohybrids which were fabricated as described in one or more exemplary embodiments, was studied through an exemplary 3-(4,5-dimethylthiazol-2-yl)-2,5 diphenyltetrazolium bromide (MTT) assay using L929 mouse fibroblast cells. FIG. 11 shows chart 1100 of cell viability analysis of the L929 mouse fibroblast cells after 48 hours of incubating the L929 mouse fibroblast cells with different exemplary nanohybrids, consistent with one or more exemplary embodiments of the present disclosure. Referring to chart 1100, the evaluated groups using MTT assay were scaffold of carboxymethyl chitosan-gelatin 1102, carboxymethyl chitosan-gelatin scaffold containing calcium chloride 1104, carboxymethyl chitosan-gelatin scaffold containing bioglass nanoparticles 1106, and carboxymethyl chitosan-gelatin scaffold containing calcium chloride and bioglass nanoparticles 1108. Chart 1100 may reflect the biocompatibility and nontoxicity of exemplary nanohybrids.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. An element proceeded by “a” or “an” does not, without further constraints, preclude the existence of additional identical elements in the process, method, article, or apparatus that comprises the element.

Unless otherwise stated, all measurements, values, ratings, positions, magnitudes, sizes, and other specifications that are set forth in this specification, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study, except where specific meanings have otherwise been set forth herein. Relational terms such as “first” and “second” and the like may be used solely to distinguish one entity or action from another without necessarily requiring or implying any actual such relationship or order between such entities or actions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter. While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for synthesizing a nanohybrid, comprising:
forming a polymer solution by dissolving carboxymethyl chitosan and gelatin in a 2-(N-Morpholino)ethanesulfonic acid (MES) buffer, the polymer solution comprising carboxymethyl chitosan and gelatin with a weight ratio (carboxymethyl chitosan:gelatin) between 0.25:0.75 and 0.75:0.25, wherein the MES buffer has a pH level between 3.5 and 4.5;
forming a first solution by adding (3-Glycidyloxypropyl)trimethoxysilane (GPTMS) to the polymer solution, the first solution comprising GPTMS with a concentration between 0.01 M and 0.05 M;
forming a second solution by adding an acid-hydrolyzed tetraethyl orthosilicate (TEOS) solution to the first solution;
forming a third solution by adding a calcium chloride (CaCl₂) solution to the second solution;
forming a fourth solution by adding 1 ethyl-3-(3-dimethylaminopropyl) carbodiimide (EDC) and N-hydroxysuccinimide (NHS) to the third solution, the fourth solution comprising:
CaCl₂ with a concentration between 0.01 M and 0.06 M;
EDC with a concentration between 0.05 M and 0.15 M;
NHS with a concentration between 0.05 M and 0.15 M; and
TEOS with a concentration between 0.05 M and 0.10 M;
forming a frozen nanohybrid by placing the fourth solution at a temperature level between -18° C. and -22° C. for a time duration between 12 and 48 hours; and
thawing the frozen nanohybrid by placing the frozen nanohybrid at a temperature level between 4° C. and 25° C. for a time duration between 8 and 24 hours.

2. A method for synthesizing a nanohybrid, comprising:
forming a polymer solution by dissolving carboxymethyl chitosan and gelatin in a 2-(N-Morpholino)ethanesulfonic acid (MES) buffer, the MES buffer having a pH level between 3.5 and 4.5;
forming a first solution by adding (3-Glycidyloxypropyl)trimethoxysilane (GPTMS) to the polymer solution;
forming a second solution by adding an acid-hydrolyzed tetraethyl orthosilicate (TEOS) solution to the first solution;
forming a third solution by adding a calcium chloride (CaCl₂) solution to the second solution;
forming a fourth solution by mixing the third solution with a solution of 1 ethyl-3-(3-dimethylaminopropyl) carbodiimide (EDC) and N-hydroxysuccinimide (NHS), wherein the solution of EDC and NHS comprises EDC and NHS with a molar ratio (EDC:NHS) between 0.8:1.2 and 1.2:0.8;
forming a frozen nanohybrid by placing the fourth solution at a temperature level between -18° C. and -22° C. for a time duration between 12 and 48 hours; and
thawing the frozen nanohybrid by placing the frozen nanohybrid at a temperature level between 4° C. and 25° C. for a time duration between 8 and 24 hours.

3. The method of claim 2, wherein forming the polymer solution by dissolving carboxymethyl chitosan and gelatin in the MES buffer comprises dissolving carboxymethyl chitosan with a degree of substitution (DS) between 0.5 and 1.5 and gelatin in the MES buffer.

4. The method of claim 3, wherein the polymer solution comprises carboxymethyl chitosan with the DS between 0.5 and 1.5 and gelatin with a weight ratio (carboxymethyl chitosan:gelatin) between 0.25:0.75 and 0.75:0.25.

5. The method of claim 3, wherein the MES buffer has a pH level between 3.5 and 4.5.

6. The method of claim 2, wherein the first solution comprises GPTMS with a concentration between 0.01 M and 0.05 M.

7. The method of claim 2, wherein adding the acid-hydrolyzed TEOS solution to the first solution comprises adding the acid-hydrolyzed TEOS solution with a TEOS concentration between 10 M and 20 M to the first solution.

8. The method of claim 7, wherein the acid-hydrolyzed TEOS solution comprises hydrogen chloride (HCl) with a concentration between 0.4 M and 0.6 M.

9. The method of claim 2, wherein the fourth solution comprises CaCl₂ with a concentration between 0.01 M and 0.06 M.

10. The method of claim 2, wherein the fourth solution comprises EDC with a concentration between 0.05 M and 0.15 M.

11. The method of claim 2, wherein the fourth solution comprises NHS with a concentration between 0.05 M and 0.15 M.

12. The method of claim 2, wherein the fourth solution comprises TEOS with a concentration between 0.05 M and 0.10 M.

13. The method of claim 2, wherein placing the fourth solution at the temperature level between -18° C. and -22° C. for the time duration between 12 and 48 hours comprises placing the fourth solution at -20° C. for a time duration of 24 hours.

14. The method of claim 2, wherein thawing the frozen nanohybrid by placing the frozen nanohybrid at the temperature level between 4° C. and 25° C. for the time duration between 8 and 24 hours comprises thawing the frozen nanohybrid by placing the frozen nanohybrid at 4° C. for a time duration between 8 to 24 hours.
